(19) United States
(12) Patent Application Publication
(10) Pub. No.: US 2004/0263556 A1
(43) Pub. Date: Dec. 30, 2004

(54) Servicing printheads

(75) Inventors: Martin Urrutia, Barcelona (ES); Antonio Monclus, Barcelona (ES); Jose Luis Valero, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/819,993

(22) Filed: Apr. 8, 2004

(30) Foreign Application Priority Data
Apr. 9, 2003 (GB) 0308203.9

(51) Int. Cl. B41J 2/165

(52) U.S. Cl. 347/22

(57) ABSTRACT

A hardcopy device comprises a printhead which extends across a print media path, and movable service station components which are moved in a direction parallel to the longitudinal axis of the printhead and into a position between the printhead and the print media path, whereby to undertake a servicing operation on the printing member. The printheads are lifted away from the print media path to allow the movement of the service station components. The service station components may move along a track which is angled to one side of the hardcopy device. Different service station components may be provided at opposite sides of the hardcopy device.

### FIELD OF THE INVENTION

The present invention relates to a method of servicing the printheads of hardcopy devices and to a hardcopy device employing such a method. In particular it relates to a service station for undertaking various servicing operations such as wiping and capping the printheads of an inkjet printer of page wide array configuration.

### BACKGROUND OF THE INVENTION

Inkjet printers can be divided into two types, viz. those with scanning printheads (in which the printheads are mounted on a movable carriage which undertakes scanning movements across a print media) and those with printheads or print bars which do not move across the print media but actually extend across substantially the entire width of the print media (so-called page wide arrays). Such printheads may be referred to as “fixed” printheads although it will be appreciated that they are capable of movement in a direction towards and away from the print media, It is common to define three mutually-orthogonal axes x, y and z in which the x-direction is the direction of print media advance through a printer, the y-direction is the direction across the print media, i.e. the scanning direction in a printer of scanning type, and the z-direction which is perpendicular to the print media in the printing zone. Thus the “fixed” printheads are capable of movement in the z-direction.

To service printheads of the scanning type, it is known to provide a service station at one end of the scanning path of the printer and to move the printheads to the service station when a servicing operation is required. It is possible to employ a similar method for servicing printheads or print bars which do not move in the scanning direction during printing, but a relatively complex mechanism is required to transport all the printheads or the entire print bar to and from the service station.

U.S. Pat. Nos. 6,398,340; 6,328,412; 6,168,258; and 5,889,535; and GB Patent Applications 2,323,459A; 2,351,946A, disclose scanning-type printers with a service station arranged at one end of the scanning axis.

U.S. Pat. No. 6,139,128 and EP Patent Application 1080909A disclose scanning-type printers in which different printhead-servicing components are fixed at opposite ends of the printer.

U.S. Pat. No. 5,432,539 discloses a full-width printer with a pivotal printhead carriage which pivots about its longitudinal axis between a printing disposition and a wiping disposition in which it is serviced by a wiper.

### SUMMARY OF THE INVENTION

Certain aspects of the present invention seek to overcome or reduce the above problem.

According to a first aspect of the present invention, there is provided a hardcopy device comprising a printing member having a longitudinal axis extending transversely of a print media path of the hardcopy device, and a movable service station member, said service station member being movable in a direction generally parallel to said longitudinal axis and into a position between said printing member and said print media path, whereby to undertake a servicing operation on said printing member.

An advantage of such an arrangement is that a relatively simple mechanism can be employed to transport the service station modules to and from the printing zone. This is partly because the position which the service station modules occupy, when servicing is not being undertaken, does not need to be particularly precise. This is in contrast to the position of a printhead or print bar, the precise positioning of which is important to maintaining high print quality.

In a preferred embodiment said printing member is mounted so that it can be moved in a direction away from said print media path from a first position to a second position, said printing member being arranged, in said first position, to print on a print media passing along said print media path, and said printing member being arranged, in said second position, to permit said service station member to move between said printing member and said print media path to undertake said servicing operation. A mechanism is provided for moving the printing member between its first and second positions. The mechanism is arranged to return the printing member precisely to its first position, so that a high print quality can be maintained. Since the printing member moves linearly, the movement may be effected in an accurate manner.

In one embodiment the printing member has a third position between said first and second positions. In this case, the second position is for allowing said service station member to move into its operative position, and the third position is for allowing actual implementation of the servicing operations.

In a preferred arrangement said service station member is mounted on a track, said track extending across the entire width of said print media path and projecting beyond said print media path at least at one side of said hardcopy device and said service station member is movable along said track between a first position and a second position, said service station member in said first position being located at one side of said print media path and said service station member in said second position being located between said printing member and said print media path. This arrangement permits convenient storage of the service station member when it is not in its operative position, i.e., when it is in its rest position. Arrangements in which the track projects beyond the print media path at both sides have different advantages in different embodiments. In embodiments of a first type, in which the service station member comprises a plurality of service station modules which, in their rest position, are all located at the same side of the print media path, the track position projecting at the other side of the print media path, permits one or more service station modules to be removed from their operative position to give access to the printing member to other service modules. In embodiments of the second type, the service station member comprises one or more service station modules arranged, in their rest positions, at opposite sides of the print media path, thus permitting a more symmetrical appearance of the hardcopy device and an increase in stability.

In preferred embodiments, the track comprises mutually-adjoining first and second parts, said first part extending across said print media path at a substantially constant distance therefrom, and said second part extending at an angle to said first part. Such a hardcopy device has a reduced “footprint” i.e. a smaller width in the y-direction coupled to a device with a completely straight track.

Alternatively, or in addition, said service station member comprises a plurality of service station carriages mounted on said track, said carriages being capable of movement relative to each other as they are transferred along said track from said first position to said second position, whereby said carriages, in said first position, have a relatively small overall dimension in the direction parallel to said longitudinal axis, and said carriages, in said second position, have a relatively large overall dimension in the direction parallel to said longitudinal axis. Such an arrangement also has the advantage of permitting the total width of the hardcopy device to be reduced.

According to a second aspect of the present invention, there is provided a hardcopy device comprising a printing member having a longitudinal axis extending transversely of a print media path of the hardcopy device, and first and second movable service station components located at opposite sides of the hardcopy device, said service station components being movable in a direction generally parallel to said longitudinal axis and into positions between said printing member and said printing media path, whereby to undertake a servicing operation on said printing member, wherein said first component has a motor arranged to drive it into a servicing position, and said second component is connectable to said first component so that said motor can pull said second component into a servicing position.

Said first component is preferably a relatively frequently used service station component and said second component is preferably a less frequently used service station component.

Said first component preferably comprises a printhead wiping component including a wiping carriage. Said second component preferably comprises a printhead capping component comprising one or more capping carriages.

Said carriages preferably travel on the same guides, e.g. tracks extending beneath the printing member.

According to a third aspect of the present invention, there is provided a service station for a printing member of a hardcopy device comprising a first service station component arranged to be disposed at one side of the hardcopy device and a second service station component arranged to be disposed at an opposite side of the hardcopy device, said first component having a motor arranged to drive it into a deployed position adjacent the printing member, and said second component being connectable to said first component whereby said motor can pull said second component into a deployed position adjacent the printing member.

According to a fourth aspect of the present invention, there is provided a service station for a hardcopy device comprising a printing member defining a longitudinal direction, said service station comprising a track and at least one service station module mounted movably along said track, said track comprising first and second parts, said first part being arranged to extend along said printing member in said longitudinal direction and said second part being arranged to project in said longitudinal direction beyond said printing member, wherein said at least one service station module is movable between a rest position occupying said second track part to an operative position occupying said first track part, whereby in said operative position said at least one service station module is capable of undertaking a servicing operation on said printing member.

According to a fifth aspect of the present invention, there is provided a service station module for a hardcopy device and capable of movement along an elongate track, said module comprising a plurality of carriages having respective track-engaging elements whereby said carriages can move along said track, said carriages also comprising mutually engaging link members whereby said carriages can be transferred from a first relative position to a second relative position, said carriages having a smaller overall dimension along said track in said first relative position than in said second relative position.

In a preferred module, the carriages are arranged in at least first and second rows along said track wherein, in said first position, there is a substantial or total overlap along said track between carriages in said first row and adjacent carriages in said second row, and, in said second position, there is a relatively small or no overlap along said track between carriages in said first row and adjacent carriages in said second row. Such an arrangement enables the width of the module to be kept to a minimum. Thus the width of the service station, of which the module is part, is also kept to a minimum.

According to a sixth aspect of the present invention, there is provided a method of servicing a printing member of a hardcopy device comprising undertaking a first printhead servicing operation by moving in a first service station component from a first end of the printing member and undertaking a second printhead operation by moving in a second service station component from the second end of the printing member, the second service station component being moved in by connecting it to the first service station component, after the first service station component has been moved to the second end, and then moving in the first and second service station components together.

According to a seventh aspect of the present invention, there is provided a computer program comprising program code for performing the method in accordance with the sixth aspect.

As used herein, the expression “hardcopy device” embraces all types of apparatus which apply indicia to print media and embraces all types of printers, photocopies, facsimile machines and scanners.

The expression “printing member” includes a print bar which has a plurality of nozzles and which extends across the entire width of the print media (and also across the underlying platen of the hardcopy device). The expression “printing member” also includes arrangements comprising a plurality of individual printheads which each have a plurality of nozzles and which together extend across the entire width of the print media; the individual printheads may be arranged end to end or they may be arranged in mutually staggered formation in two or more rows extending across the print media, possibly with printheads in adjacent rows having a partial mutual overlap. A single “printing member” may be provided for a single colour, e.g. black. Alternatively, a plurality of “printing members” each corresponding to a different colour may be provided spaced along a direction perpendicular to said printing member longitudinal axis, i.e. along a direction parallel to the direction of print media advance through the hardcopy device. An additional printing member may be provided for applying fixer to the print media.

A service station is a component part of a hardcopy device which is typically fixedly located at one end of the printing member, i.e. at the side of the hardcopy device and undertakes one or more operations on the printheads.

Usually a service station undertakes a plurality of different operations on the printheads. Each operation is undertaken by a respective part of the service station known as a servicing module. Thus a service station comprises a plurality of servicing modules.

The servicing modules in embodiments of the present invention are movable between a “rest” position and an “operative” position. In the “rest” position, also known as a “home” position, they are not in use and are located so as not to prevent or interfere with a printing operation by the printing member. In the “operative” position the servicing modules are located such that they can undertake a servicing operation on the printing member.

The term “parking” relates to returning a service station component to its rest position.

### BRIEF DESCRIPTION OF THE DRAWINGS

Preferred embodiments of the present invention will now be described, by way of example only, with reference to the accompanying drawings, of which:

FIG. 1 is a schematic perspective view of an inkjet printer in accordance with a first embodiment of the present invention and in a printing disposition;

FIG. 2 is a view of the arrangement shown in FIG. 1 with the printing member raised in a direction away from the print media;

FIG. 3 is a view of the arrangement shown in FIGS. 1 and 2 with a service station moved in to a servicing disposition;

FIG. 4 is a perspective view of a connecting arrangement for use in embodiments of the present invention;

FIG. 5 is a schematic top plan view of a modified service station;

FIG. 6 is a schematic top plan view of a modified capping module of a service station;

FIG. 7 is a schematic perspective view similar to FIG. 1 of the modification of FIG. 6;

FIG. 8 is a perspective view of the printing mechanism of a hardcopy device in accordance with a second embodiment of the present invention;

FIG. 9 is an enlarged sectional side view of a wiping carriage of the device of FIG. 8; and

FIG. 10 is a schematic side view showing the engagement between the wiping carriage of FIG. 9 and a capping carriage.

### DETAILED DESCRIPTION OF THE PREFERRED EMBODIMENTS

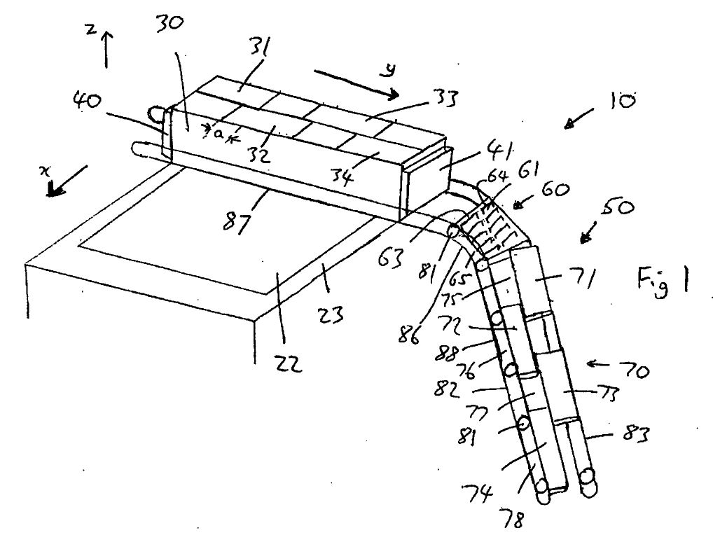

Referring to the drawings, FIG. 1 shows a page wide array inkjet printer 10 comprising a platen 23 over which a print media 22 is moved in a direction of media advance indicated by arrow x. A printing member in the form of a print bar 30 is mounted above the platen 23 and extends across substantially the entire width of print media 22 in the direction indicated by arrow y. Print bar 30 does not move in the x or y directions relative to platen 23 but can be lifted by means of a mechanism 40, 41 in a direction away from and towards the platen 23 as indicated by arrow z.

As shown, print bar 30 has mounted therein four replaceable printheads 31, 32, 33 and 34 each comprising a plurality of nozzles arranged to fire ink in swaths of a single colour on to a print media 22 as it is intermittently moved under the print bar in the x-direction. To ensure that there are no gaps in the image printed on media 22, each printhead has an extent in the y-direction which is slightly greater than one quarter of the total length of the print bar 30. The printheads 31-34 are thus arranged in a staggered formation such that adjacent ones mutually overlap by a distance “a”.

In a printing operation, printing instructions are given to the printheads to fire an appropriate pattern of ink on to the print media 22 in a printing zone as the print media advances between successive printing positions in the x-direction.

At intervals, it is required to undertake a servicing operation on the print bar 30. For this purpose, a service station 50 is mounted at one side of the printer 10. The service station comprises a wiping module 60 and a capping module 70. Each of the modules 60, 70 is mounted on rollers 81, which roll along track members 82, 83 which extend from the service station 50 across the entire width of platen 23. As shown, each track member 82, 83 comprises a metallic bar which is bent back on itself to define a loop, with the rollers travelling between opposed sides of the loop. There is a bend 86 between the parts 87 of the track members which extend over the platen 23 and the parts 88 of the track members which are not over the platen, so that the parts 88 extend downwardly at an angle.

Wiping module 60 comprises a plurality of rubber wiping blades 61 with their blade edges extending generally in the x-direction. The blades are arranged on a wiper carriage 65 in first and second rows 63, 64 extending in the y-direction, with the rows being separated by a gap. The position of blade row 63 in the x-direction corresponds to the position in the x-direction of printheads 32 and 34. The position of blade row 64 in the x-direction corresponds to the position in the x-direction of printheads 31 and 33.

Capping module 70 comprises four substantially rectangular caps 71, 72, 73, 74 of rubber or other elastomeric material. Each cap is mounted on a respective capping carriage 75, 76, 77, 78 which are attached to each other and are each mounted on rollers 81. As will be described later, each carriage includes a camming and lifting mechanism for moving the respective cap away from and back towards the carriage.

It will be noted that, in top plan view, there is a substantial overlap in the y-direction of the service station modules 60,70 and of their carriages 65,75,76,77 and 78.

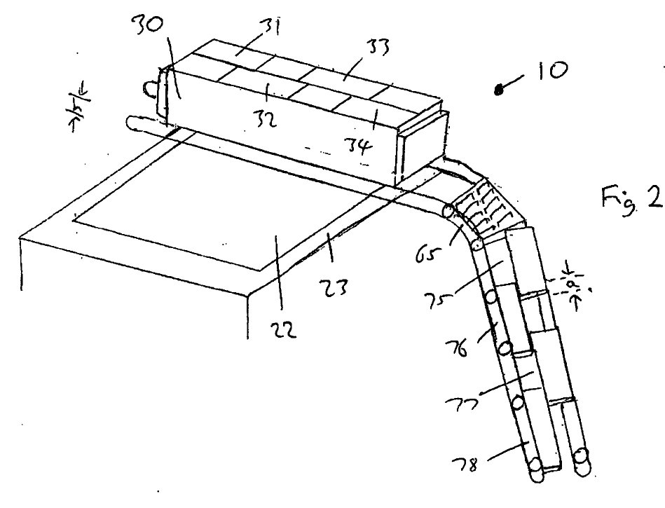

To undertake a servicing operation on the print bar 30, it is first raised by lifting mechanism 40, 41 by a distance “h” in the z-direction away from platen 23 as shown in FIG. 2. This procedure provides enough space for the service station modules 60 and 70 to be moved under the raised print bar 30 to undertake various servicing operations, as will now be described in connection with FIG. 3.

To effect a nozzle-wiping operation, wiper carriage 65 is pulled by means of an entrainment mechanism (not shown) across the entire width of the printer 10 to the far end 89 of track members 82, 83. As wiping module 60 travels along its path in the y-direction, the blades in row 64 wipe ink residues off printheads 31 and 33 and the blades in row 63 wipe off printheads 32 and 34. Wiper carriage 65 is fixedly attached to the first capping carriage 75, so that, when the wiper carriage 65 reaches the far end 89 of track members 82, 83, the caps 71 to 74 have moved so as now to be located below their respective printheads 31 to 34. The caps 71 to 74 also have a mutual overlap corresponding to “a” the overlap of the printheads. It will be seen that the service station modules 60,70 constitute an articulated train of carriages.

To effect a capping operation, the capping carriages 75 to 78 are moved slightly further to the left in FIG. 3. This causes fixed formations (not shown) on the printer 10 to engage the camming and lifting mechanism on each capping carriage to cause the respective caps to be lifted up to engage and seal around the edges of the respective printheads. The caps 71 to 74 are mounted on springs so that a good seal can be maintained in each case. This serves to reduce evaporation at the inkjet nozzles of volatile components of the ink and to prevent the access of dust and dirt to the nozzles when the printer is not in use.

When it is desired to continue printing again, the capping carriages 75 to 78 are moved slightly to the right in FIG. 3. This causes the camming and lifting mechanism to disengage the caps 71 to 74 from the printheads 31 to 34 and to lower the caps, i.e. to move them away from the printheads. The servicing modules 60, 70 are now moved back to their disposition in FIG. 2, the print bar 30 is lowered to its position shown in FIG. 1 and printing can recommence.

Of course, if only a wiping operation is required, the steps of lifting and lowering the caps 71 to 74 are omitted and the servicing modules 60, 70 are returned to their FIG. 2 disposition immediately after a wiping operation.

The above-described arrangement has numerous advantages. In particular, the print bar 30 is required to move only in a single direction, which allows the use of a relatively simple lifting mechanism whilst retaining the necessary precision. In addition the movements in the y-direction of the service station modules themselves automatically effect the servicing functions of wiping and capping the printheads. In addition, the printhead wiping occurs in the y-direction which has the advantage of cleaning the nozzles of the printhead in the direction of the rows of nozzles. Moreover, the movement in the y-direction avoids any problems caused by the overlap “a” of adjacent printheads 31 to 34; in particular, if the service station modules approached the printheads from the x-direction, the overlap “a” would cause problems of access to the printheads. In addition, the arrangement necessitates no increase in the dimension of the printer 10 in the x-direction.

The pulling arrangement of the carriages ensures that, during movement thereof, the desired separation therebetween is maintained by gravity. This also ensures that the carriages simultaneously reach their correct positions. The carriages are subsequently pushed by the entrainment mechanism via carriage 65 in the opposite direction towards their rest position, and this is acceptable because during this procedure their precise position is not so important.

Although the positioning of the service station 50 to one side of the printer increases the overall width of the printer, the bending down of the track members 82, 83 ensures that the increase is smaller than if the track members were rectilinear.

An advantage of the attachment to each other of the carriages 65,75,76,77 and 78 is that an entrainment mechanism needs to be provided for only one of them (i.e. wiper carriage 65), the others being entrained automatically. This advantage applies to both directions of movement.

Various modifications may be made to the above-described arrangement. For example, the parts 88 of track members 82, 83 extending beyond the platen 23 may be arranged at any desired angle downwardly or upwardly relative to the parts 87 extending across the print media path and may even extend vertically down or vertically up. Alternatively, or in addition, they may extend forwardly or backwardly. If the width of the printer is not crucial, the track members 82, 83 may be entirely horizontal. The carriages 65 and 75 to 78 may be arranged to slide on the track members 82, 83 which may comprise a suitable combination of projections and grooves.

Any suitable number of wiping blades 61 from one upwards may be provided in each row 63,64. Instead of blades being arranged in rows, the or each wiping blade 61 may extend across the entire wiping module in the x-direction, so that a single blade can wipe two or more printheads.

The rubber wiper blades 61 may be replaced by a textile wiping arrangement. An advantage of using textile wipers by moving them in the y-direction is that a smaller area of textile web material is required.

Instead of being driven via wiper carriage 65, the carriages may be driven via one of the capping carriages, and in particular the end carriage 78; since this involves pushing carriages 75 to 78 into their responsive capping positions, this is not optimal. The entrainment mechanism for driving the carriages may comprise a drive motor and/or a belt drive arrangement. Individual drive mechanisms can be provided for the carriages, but this adds cost.

Instead of all the printheads 31 to 34 being capped simultaneously, the carriages 75 to 78 may arrive at successive points in time at their respective operative positions and may each cap their respective printhead immediately upon arrival without waiting for the remaining carriages to reach their operative positions. Cap removal from the printheads may similarly occur successively rather than simultaneously.

The camming mechanisms which serve to lift the caps 71 to 74 may also serve to locate the respective carriages 75 to 78 in their correct position on the track. Instead of being cam-operated, a conventional capping system may be employed.

In other modifications a separate wiper carriage 65 is provided for each printhead 31 to 34. In this case the wiper carriages may be interspersed with the capping carriages 71 to 74. The or each wiper carriage 65 may incorporate a camming and lifting mechanism (similar to that of a capping carriage) for bringing the wiper blades 61 into engagement with their respective printheads only after the wiping carriage has been brought into its correct allotted position between the print bar and the print media. This arrangement ensures that a wiper does not wipe printheads for which it is not intended, which might produce undesired mixing of different inks.

Means may be provided for cleaning the parts of the wiper module 60 between wiping operations of the printheads.

The number of printheads 31 to 34 extending across the platen 23 may be selected as desired, provided that a similar number of capping carriages 71 to 74 is provided. There may be more than three rows of printheads, and hence capping carriages also.

Instead of comprising a plurality of printheads 31 to 34, the print bar 30 may comprise a single printhead extending across the entire width of the platen 23. In this case, the capping carriages 31 to 34 are aligned in an end to end formation rather than the mutually-staggered formation shown in FIG. 1. Also in this case the number of capping carriages is arbitrary, but if a relatively small number is provided so that each carriage has a relatively large length in the y-direction, a degree of flexibility needs to be incorporated in their individual construction so that they can pass around the bend 86 between the two parts 88,87 of the track members 82, 83.

As mentioned above, print bar 30 is arranged to fire ink of a single colour. Accordingly, four print bars 30 and four associated service stations 50 may be provided along the x-direction to print full colour printing, corresponding to black, cyan, magenta and yellow coloured inks. Other numbers of print bars 30 may be provided apart from one and four. The service station module 60 and/or 70 for the various coloured inks may be ganged together so that wiping and/or capping of all the printheads occurs simultaneously. Alternatively, the wiping modules 60 and the capping modules 70 for the various coloured inks may be combined into a single service station 50.

Although there have been disclosed arrangements with one or more printheads which remain stationary during printing operations, embodiments of the present invention may comprise scanning type printers, in which the or each printhead moves across the print media during printing operations.

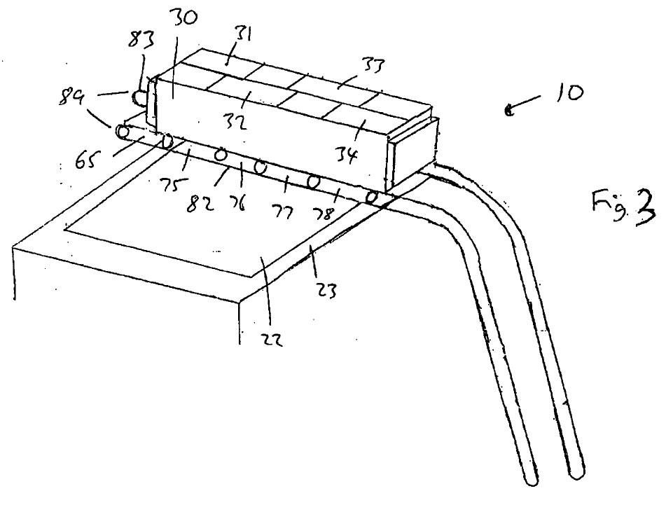

In another modification, the wiper carriage 65 and the adjacent capping carriage 75 are arranged to be detachably connected. FIG. 4 shows an enlarged view of a connecting arrangement 140 for such a modification. The connection arrangement comprises a first hook element 141, rotatably mounted at pivots 151,152 on the first capping carriage 75, and a second hook element 142 fixed by a web portion 153 and brackets 154a, 154b to wiping carriage 65. Element 141 moves under the influence of a compression spring 148 which is urged against a spigot 148a of element 141.

As the entrainment mechanism moves wiping carriage 65 in the y-direction, hook element 141 moves towards and away from hook element 141. When it is desired to attach carriage 75 to the carriage 65, the carriage 65 is moved against carriage 75 and inclined surface 143 of hook portion 144 of element 142 slides along included surface 146 of hook portion 147 of element 141. During this movement, element 141 is rotated upwardly and, when portion 144 has passed portion 147, downwardly so that portions 144 and 147 are then mutually engaged to allow capping module 70 to be moved to the position where it caps the printing member.

When capping is no longer required, the caps are disengaged from the printheads and the module 70 is again moved to the side of the printer to return module 70 to its rest position. Upon moving hook element 142 slightly further towards hook element 141 the latter falls into a gap 149 between hook portion 144 and web portion 153. The hook element 141 is thus rotated downwardly and allows hook element 141 to retract freely away from the capping module 70. Until hook element 142 is again returned to connect to hook element 141, wiping operations take place without module 70 moving with module 60.

Thus, if only a wiping operation is required, then the capping carriage 75 is disconnected and only wiping carriage 65 moves across the printer to wipe the printheads and then back to its original position shown in FIG. 1. This has the advantage of imposing less of a load on the entraining mechanism driving carriage 65 and enables the wiping operation to occur more quickly. If a capping operation is required, the capping carriage 75 is connected to wiping carriage 65 and the whole capping module 70 is moved into the capping position, as shown generally in FIG. 3.

Various further modifications can be made to the arrangement of FIG. 4. For example the rotatable hook element 141 may be attached to the carriage 75 with hook element 142 being attached to the carriage 65. Instead of hook elements 141 and 142 the carriages 65 and 75 can be detechably connected via a magnetic or electromagnetic arrangement.

If desired the track members 82, 83 may also extend beyond the platen 23 further to the left of FIG. 1 and the wiper carriage 65 is located at one side of the printer with the capping carriages 75 to 78 being arranged at the other side. This has the advantage that only that module is moved which is necessary for a particular desired servicing operation.

The capping carriages 75 to 78 can be modified by omitting the camming and lifting mechanisms for lifting the caps. In this case, after the capping module 70 has been moved into the capping position as shown in FIG. 3, the print bar is lowered by a distance “j” which is typically less than “h” to a height between those shown in FIGS. 1 and 3. In this position, the print bar 30 seals the printheads 31 to 34 on to the caps 71 to 74.

FIG. 5 shows a modified service station 50′ in which service station modules 60′,70,110′ are selectively introduced into an input region 90 for selectively servicing the printheads of print bar 30. Thus a select mechanism (not shown) is provided for introducing a wiping module 60′ or a cleaning and lubricating fluid (e.g. PEG) application module 110′ into the zone 90 or for moving capping module 70 across zone 90 and along the print bar 30.

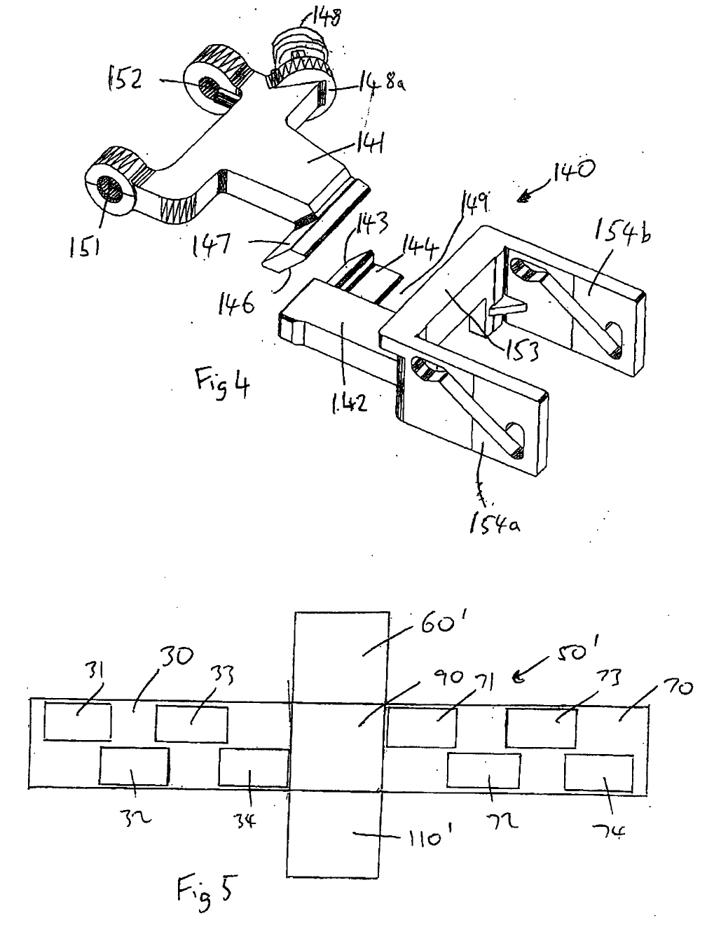

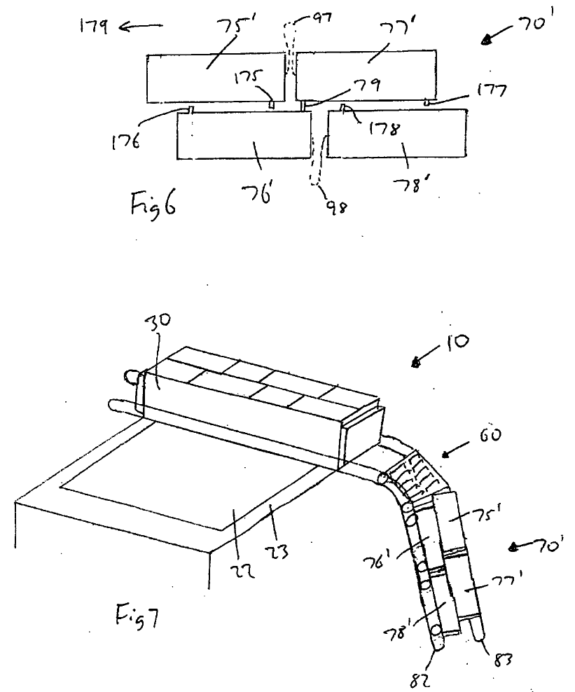

FIGS. 6 and 7 show a modified capping module 70′ for a service station 50 or 50′ in which the individual capping carriages 75′ to 78′ are not fixedly attached to each other. Instead, carriage 75′ has a projection 175 which is arranged to drivingly engage a projection 176 on carriage 76′. Carriage 76′ is fixedly attached via a link 79 to carriage 77′, and carriage 77′ has a projection 177 which is arranged to drivingly engage a projection 178 on carriage 78′.

In use, when carriage 75′ is moved by the entrainment mechanism to the left as indicated by arrow 179 towards its capping position, projections 175 engages projection 176 to entrain carriage 76′ with the desired degree of overlap “a” of the carriages. Since carriage 77′ is fixed to carriage 76′ by link 79, it moves along therewith and projection 177 subsequently engages projection 178 to entrain arise 78′ with the desired degree of overlap “a”. This arrangement has the advantage of further reducing the dimension of the entire printer 10 in the y-direction. The connection between the capping carriages may be achieved by any suitable mechanical links and can be replaced or supplemented by connecting lines 97, 98 as shown in dotted lines in FIG. 5. It may be so arranged that carriage 77′ is linked to carriage 75′ and that carriage 78′ is linked to carriage 76′. Other linking arrangements may be employed. It will be noted that in all the described arrangements, the carriages are free to move relative to each other while maintaining their order; they are correctly positioned in a relatively spaced out configuration so that they can service the printheads in their operative position, but are positioned closer to each other when at the side of the hardcopy device in their rest position to save space.

One or more servicing modules may be provided in addition to the modules for wiping, capping and applying a cleaning and lubricating fluid. Such additional modules may be used for scraping the nozzles, snout wiping, priming the nozzles or drop detection.

The modules may be arranged at one or both sides of the hardcopy device and may be incorporated into the articulated train of modules as desired. To actuate this service station there are required two motors, e.g. one motor for the capping carriages and one motor for the wiping carriage. Each of these motors has an associated transmission and control system.

Only a single servicing module may be provided.

Referring now to FIG. 8 there is shown a printing mechanism 200 of a hardcopy device in accordance with a second embodiment of the present invention and in the form of an inkjet printer. The printer comprises a printing member 201 located above a platen 202. Printing member 201 is held so that it cannot move in directions in a parallel to the plane of the platen 202. Lifting mechanisms 204, driven by respective motors, are provided which can move the printing member in directions indicated by double headed arrow B, i.e. perpendicular to the place of platen 202. A print media (not shown) moves between printing member 201 and 202 in the direction of arrow A. It will be seen that print bar 201 has a longitudinal axis which extends across the width of the printer in a direction perpendicular to the arrow A. As disclosed above, the printing member comprises four slightly-overlapping printheads (not shown) extending in staggered configuration across the width of the printer.

Extending across substantially the entire width of the printer, there are provided two guide rails 205, 206. The guide rails are fixedly mounted to corner posts 207 of the platen 202 so that the rails are held at a spacing above the central region of the platen.

Movably mounted on the guide rails 205, 206 at one side of the printer is a wiping component comprising a wiping carriage 210. The carriage comprises a housing 211 having on its exterior slider members 212 which are arranged to slide on the guide rails 205, 206. The housing contains a printhead wiping mechanism 220, FIG. 8, comprising a roll of fabric material 221, FIG. 8, which is used to wipe and absorb ink from the printing member. At its end adjacent to the printing member 201, the housing 211 carries the first part 227 of a two-part mechanical connection arrangement 228.

In use of the wiping mechanism, material is unwound from a first shaft 223 and passes around roller 224, where it comes into engagement with a printhead, and is then wound around a second shaft 226. Means (not shown) are provided for advancing the material 221 through the roller mechanism so that the printhead is wiped by a fresh and clean part of the material.

A drive arrangement 230 is provided for moving the wiping carriage along the guide rails 205, 206. The drive arrangement 230 comprises a motor 231, transmission gears 232, 233 and drive cables 235. The drive cables 235 are held at their remote ends by support devices 237.

At the opposite side of the printing mechanism, there is provided a capping component 240 comprising four capping carriages 244 having slider members 242 so that they can undertake sliding movements along guide rails 205, 206. Each carriage 244 comprises a printhead cap 245 corresponding to a respective one of the four printheads of the printing member 201. At its end adjacent to the printing member 201 a leading one 244a, FIG. 10, of the capping carriages 244 carries the second part 247 of the two-part connection arrangement 228.

The two part connection 228 has the construction shown in FIG. 4 above.

During a printing operation, ink is fired from the printing member 201 on to a print media as it passes underneath in the direction of arrow A. At certain times, there will be an operating requirement to undertake a wiping operation, in which accumulated ink and ink residues are removed from the inkjet nozzles. This may arise at the end of a printing operation. It may also arise after the elapse of a certain amount of printing time or after the use of a predetermined volume of ink; in these cases the need for wiping away may arise part way during the printing of a print media.

To undertake a wiping operation, mechanisms 204 are used to lift printing member 201 away from platen 202 to a first height which is sufficient to allow wiping carriage 210 to pass there under to effect the wiping operation. Carriage 210 is then moved from its starting position at one side 250 of the printing mechanism shown in FIG. 8 across the printer to its other side 260, so that the part of material 221 wrapped around roller 224 wipes the printheads of printing member 201 in the process.

If it is then required to initiate or continue a printing operation, the wiping carriage is returned to and parked in its original starting position shown in FIG. 8. The printing member 201 is then lowered to its original printing position and printing is commenced or recommenced.

If, however, it is required to follow the wiping operation with a printhead capping operation, the wiper, while still at the other side 260 of the printing mechanism 200, is connected to the leading capping carriage 244a. This is achieved by moving connection parts 227, 247 into contact with each other so that they automatically intergage.

Before the capping carriages are moved, mechanisms 204 are used to lift printing member 201 further away from platen 202 to a second height which is sufficient to allow wiping carriage 210 to pass thereunder without making contact with the printheads.

Wiping carriage 210 is then returned to side 250 of the printing mechanism, during which movement the capping carriages 244 are deployed and their caps 245 are applied to the respective printheads on printing member 201. During this process, both carriages 210 and 240 are moved by motor 231. The interconnection, deployment and disengagement of the capping carriages 244 and the application of cap 245 to the printheads are effected in the same way as described in connection with the first embodiment. This involves a slight lowering of the printing member 201 towards the caps 245. After the capping carriages 244 are fully deployed, the wiping carriage 210 is disengaged from the leading capping carriage 244a and parked in the position shown in FIG. 8. To prepare the printing mechanism again for printing, the printing member 201 is slightly raised to disconnect it from caps 245 and the motor 231 is actuated to move wiping carriage 210 to cause it to push the capping carriages 244 to their initial disposition at side 260 shown in FIG. 8. Wiping carriage 210 is then returned to its initial position shown in FIG. 8 and the printing member 201 is lowered to its original height for printing shown in FIG. 8.

Of course, it may alternatively be desired to pass straight from the printing position shown in FIG. 8 to a position in which the printheads are capped. In this case, printing member 201 is immediately raised to its said second height. The wiping carriage 210 is then moved by motor 231 from end 250 to 260 without undertaking a wiping operation. The two parts 227, 247 of connection arrangement 228 are interengaged and motor 231 is actuated to move wiping carriage 210 in the opposite direction to pull the capping carriages 244 into their deployed positioned as described previously.

An advantage of the above-described arrangement is that only a single motor is required for the servicing operations, thus saving cost, weight and space. Printhead wiping is readily achieved along the axis of printing member 201, i.e. along the lines of the nozzles of the printheads, which has the advantage of avoiding possible contamination from ink from a different printing member. Capping is also readily achieved by movement along the same axis. Furthermore, a common guidance system can be employed in the form of guide rails 205, 206, thus leading to further cost and space savings.

A further advantage is that the wiper carriage 210 with its wiping mechanism 220 is in the same position when the printheads are capped as when printing is being undertaken. Thus maintenance and/or replacement of the wiping mechanism can be undertaken at any time. If the wiping carriage and capping carriage are both located at the same side of printer, the wiping mechanism is in a different position when the printheads are capped, which may mean that it is inaccessible for much of the time.

The arrangement of guide rails 205, 206 located at a spacing from platen 202 has the advantage that a wiping operation may be undertaken with a print media located on the platen, i.e. even part way through a printing operation on a single print media.

Various modifications may be made to the above-described arrangement. For example, instead of a fabric roll of material 221, the wiping mechanism may comprise a plurality of wiper blades, as disclosed above, or any other wiping arrangement.

Instead of having separate motors, lifting mechanisms 204 may be driven by a common motor. Drive cables 235 may be replaced by drive belts.

Some or all of the carriages may be arranged to travel on wheels 265 rather than on slider members 212, 242. In some arrangements it may be arranged for the capping carriages to travel on different guide rails than the wiping carriage.

For example, in page wide array devices for colour printing, a plurality of printing members 201 corresponding to the different colours are arranged parallel to each other and mutually spaced along the direction A of media advance. To simplify the wiping of the printheads, a common wiping mechanism 220 may be used for some or all of the printing members. Since the movement of the wiping mechanism is along the axes of the printing members, there is no danger of cross-contamination of the inks. The dimension of the wiping mechanism in the direction A is suitably increased. If all the printing member 201 of this page wide array device are always to be capped simultaneously, then a suitably-expanded capping component is provided, which can conveniently move on the same guide arrangement as the wiping component. If, however, only selected ones of the printing members are to be capped, e.g. during printing with solely the black printing member, then separate capping components with separate and selectively-operable connection arrangements 228 are provided, and these capping components travel on separate guide arrangements.

The wiping carriage 210 may incorporate a drop detector 270 which, when the wiping mechanism 220 is adjacent a printhead nozzle, can detect whether the nozzle is firing accurately.

Although it is more efficient for the more frequently-used servicing component (i.e. the wiping component) to be provided with the motor 231, it is possible for the less frequently-used servicing component (i.e. the capping component) to be provided with the motor; such an arrangement is not so convenient, because means need to be provided to prevent the caps 245 from capping the printheads when only a wiping operation is required. The wiping component and/or the capping component may be replaced by any other servicing station component such as a component for applying a cleaning and lubricating fluid, scraping the nozzles, snout wiping, priming the nozzles or drop detection.

Where a spittoon is provided, a drop detector 270 can be provided therein instead of, or in addition to, a drop detector in a wiping component and/or a separate drop detection means.

More than one servicing component may be provided at each end of the printing member 201. Thus carriage 210 may pull another service station component behind it as it moves underneath the print bar. In its parked position, this additional service station component is arranged to the left of carriage 210 in FIG. 8 and to enable it to be deployed, space is provide at the right hand end of the printing mechanism to allow carriage 210 to move out of the way. Carriage 244 may pull another service station component behind them as they move underneath the print bar. In its parked position, this additional service station is arranged to the right of carriages 244 in FIG. 8, and to enable it to be deployed, space is provided at the left hand end of the printing mechanism to allow carriages 244 in addition to carriage 210 to move out of the way. Suitable releasable connections are provided between the carriages 210, 244 and carriages for the additional service station components. Alternatively, an arrangement similar to that illustrated in FIG. 5 above may be used to introduce the additional service station components.

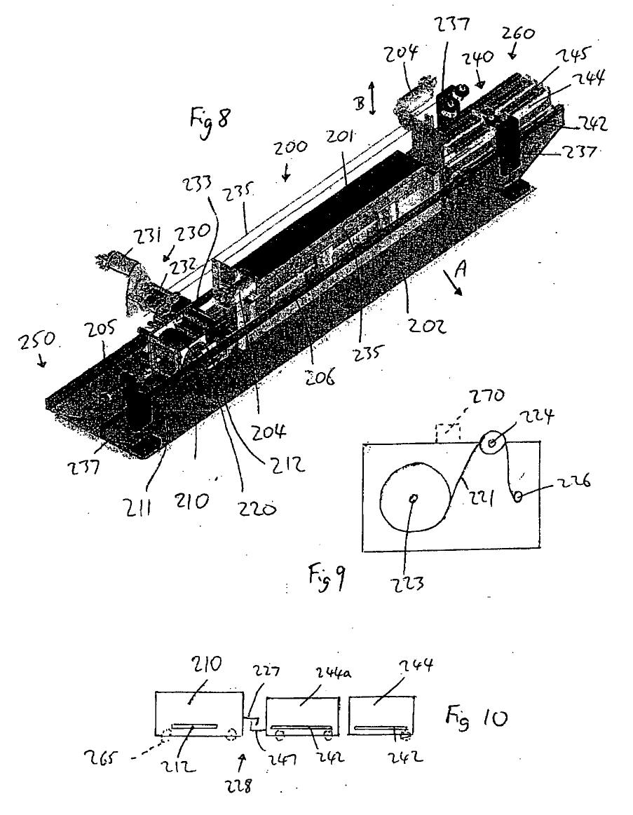

The features and modifications of the arrangements shown and described in the present application can be used as replacement for, or in combination with, the features of each other. For example the embodiment of FIGS. 8 to 10 may have angled tracks at both ends.

What has been described and illustrated herein is a preferred embodiment of the invention along with some of its variations. The terms, descriptions and Figures used herein are set forth by way of illustration only and are not meant as limitations. Those skilled in the art will recognise that many variations are possible within the spirit and scope of the invention, which is intended to be defined by the following claims and their equivalents in which all terms are meant in their broadest reasonable sense unless otherwise indicated.

What is claimed is:

1. A hardcopy device comprising a printing member having a longitudinal axis extending transversely of a print media path of the hardcopy device, and a movable service station member, said service station member being movable in a direction generally parallel to said longitudinal axis and into a position between said printing member and said print media path, whereby to undertake a servicing operation on said printing member.

2. A hardcopy device according to claim 1, wherein said printing member is mounted so that it can be moved in a direction away from said print media path from a first position to a second position, said printing member being arranged, in said first position, to print on a print media passing along said print media path, and said printing member being arranged, in said second position, to permit said service station member to move between said printing member and said print media path to undertake said servicing operation.

3. A hardcopy device according to claim 2, wherein, after said service station member has been moved into position between said printing member and said print media path, said service station member is mounted so that it can be moved in said direction away from said print media path to undertake said servicing operation.

4. A hardcopy device according to claim 2, wherein said printing member is mounted so that it can be moved into a third position between said first and second positions, said printing member being arranged in said third position to engage said service station member.

5. A hardcopy device according to claim 1, wherein said service station member comprises one or more printhead capping devices.

6. A hardcopy device according to claim 1, wherein said service station member comprises one or more printhead wiping devices.

7. A hardcopy device according to claim 1, wherein said service station member is mounted on a track, said track extending across the entire width of said print media path and projecting beyond said print media path at least at one side of said hardcopy device.

8. A hardcopy device according to claim 7, wherein said service station member is movable along said track between a first position and a second position, said service station member in said first position being located at one side of said print media path and said service station member in said second position being located between said printing member and said print media path.

9. A hardcopy device according to claim 8, wherein said service station member comprises a plurality of service station carriages mounted on said track, said carriages being capable of movement relative to each other as they are transferred along said track from said first position to said second position, whereby said carriages, in said first position, have a relatively small overall dimension in the direction parallel to said longitudinal axis, and said carriages, in said second position, have a relatively large overall dimension in the direction parallel to said longitudinal axis.

10. A hardcopy device according to claim 7, wherein said track comprises mutually-adjoining first and second parts, said first part extending across said print media path at a substantially constant distance therefrom, and said second part extending at an angle to said first part.

11. A hardcopy device according to claim 1, wherein said service station member comprises at least first and second service station components located at opposite sides of the hardcopy device, said first component having a motor arranged to drive it into a deployed position adjacent the printing member, and said second component being connectable to said first component whereby said motor can pull said second component into a deployed position adjacent the printing member.

12. A device according to claim 11, wherein said first component is a relatively frequently used service station component and said second component is a less frequently used service station component.

13. A device according to claim 11, wherein said first component comprises a printhead wiping component including a wiping carriage, said second component comprises a printhead capping component including at least one capping carriage, and said wiping carriage and said capping carriage travel on common guide means.

14. A device according to claim 11, wherein means are provided for moving the printing member between a first position in which it is arranged to print on a print media, a second position, located further away from the print media, in which said first service station component can be deployed beneath the printing member, and a third position, located further away from the print media than the second position, in which said second service station component can be deployed beneath the printing member.

15. A device according to claim 14, wherein the printing member moving means are capable of lowering the printing member by a relatively small amount from the third position to effect a printhead capping operation.

16. A hardcopy device comprising a printing member having a longitudinal axis extending transversely of a print media path of the hardcopy device, and first and second movable service station components located at opposite sides of the hardcopy device, said service station components being movable in a direction generally parallel to said longitudinal axis and into positions between said printing member and said printing media path, whereby to undertake a servicing operation on said printing member, wherein said first component has a motor arranged to drive it into a servicing position, and said second component is connectable to said first component so that said motor can pull said second component into a servicing position.

17. A service station for a printing member of a hardcopy device comprising a first service station component arranged to be disposed at one side of the hardcopy device and a second service station component arranged to be disposed at an opposite side of the hardcopy device, said first component having a motor arranged to drive it into a deployed position adjacent the printing member, and said second component being connectable to said first component whereby said motor can pull said second component into a deployed position adjacent the printing member.

18. A service station for a hardcopy device comprising a printing member defining a longitudinal direction, said service station comprising a track and at least one service station module mounted movably along said track, said track comprising first and second parts, said first part being arranged to extend along said printing member in said longitudinal direction and said second part being arranged to project in said longitudinal direction beyond said printing member, wherein said at least one service station module is movable between a rest position occupying said second track part to an operative position occupying said first track part, whereby in said operative position said at least one service station module is capable of undertaking a servicing operation on said printing member.

19. A service station according to claim 18, wherein said second track part is arranged at an angle to said first track part.

20. A service station according to claim 18, wherein said at least one service station module comprises a plurality of carriages capable of relative movement to each other in said longitudinal direction, whereby in said rest position they have an overall dimension in said longitudinal direction which is smaller than their overall dimension in said longitudinal direction in said operative position.

21. A service station module for a hardcopy device and capable of movement along an elongate track, said module comprising a plurality of carriages having respective track-engaging elements whereby said carriages can move along said track, said carriages also comprising mutually engaging link members whereby said carriages can be transferred from a first relative position to a second relative position, said carriages having a smaller overall dimension along said track in said first relative position than in said second relative position.

22. A service station module according to claim 21, wherein said carriages are arranged in at least first and second rows along said track wherein, in said first position, there is a substantial or total overlap along said track between carriages in said first row and adjacent carriages in said second row, and, in said second position, there is a relatively small or no overlap along said track between carriages in said first row and adjacent carriages in said second row.

23. A method of servicing a printing member of a hardcopy device comprising undertaking a first printhead servicing operation by moving in a first service station component from a first end of the printing member and undertaking a second printhead operation by moving in a second service station component from the second end of the printing member, the second service station component being moved in by connecting it to the first service station component, after the first service station component has been moved to the second end, and then moving in the first and second service station components together.

24. A method according to claim 23 wherein the printing member is raised or lowered as necessary to permit the movements of the service station components and the associated servicing operations.

25. A computer program comprising program code for performing the method steps of claim 23 when said program is run on a processing device associated with a suitable hardcopy device.
